(19) United States
(12) Patent Application Publication
(10) Pub. No.: US 2025/0390329 A1
(43) Pub. Date: Dec. 25, 2025

(54) METHOD AND APPARATUS, DEVICE, AND STORAGE MEDIUM FOR MEMORY PRESSURE DETECTION FOR VIRTUAL MACHINE

(71) Applicant: Beijing Volcano Engine Technology Co., Ltd., Beijing (CN)

(72) Inventors: Zhenwei PI, Beijing (CN); Rui SONG, Beijing (CN)

(21) Appl. No.: 19/057,062

(22) Filed: Feb. 19, 2025

(30) Foreign Application Priority Data
Jun. 20, 2024 (CN) 202410804949.0

(51) Int. Cl. G06F 9/455

(52) U.S. Cl. CPC G06F 9/45558; G06F 2009/45583

(57) ABSTRACT

Embodiments of the present disclosure provide a memory pressure detection method and apparatus for a virtual machine, a device, and a storage medium. A trigger instruction is sent to a virtualization monitoring unit by a memory monitoring process running in a host, where the virtualization monitoring unit corresponding one-to-one to a virtual machine to be monitored created by the host, and is configured to generate a corresponding interrupt signal in response to the trigger instruction. Memory statistical data of the virtual machine to be monitored is obtained by a kernel-mode driver of the virtual machine to be monitored in response to the interrupt signal output by the virtualization monitoring unit, the memory statistical data representing a statistical indicator for a memory reclamation process of the virtual machine to be monitored.

### CROSS-REFERENCE TO RELATED APPLICATION(S)

This application claims priority to Chinese Application No. 202410804949.0 filed Jun. 20, 2024, the disclosure of which is incorporated herein by reference in its entirety.

### FIELD

Embodiments of the present disclosure relate to the technical field of cloud computing, and in particular, to a method and apparatus, a device, and a storage medium for memory pressure detection for a virtual machine.

### BACKGROUND

In a cloud computing and virtualization scenario, when a memory pressure of a virtual machine is too high, a memory reclamation mechanism of a system is triggered to reduce the memory pressure of the virtual machine.

### SUMMARY

Embodiments of the present disclosure provide a method and apparatus, a device, and a storage medium for memory pressure detection for a virtual machine, to overcome a problem that a memory pressure of a virtual machine cannot be detected due to system memory reclamation.

In a first aspect, an embodiment of the present disclosure provides a memory pressure detection method for a virtual machine, including:
sending, by a memory monitoring process running in a host, a trigger instruction to a virtualization monitoring unit, and the virtualization monitoring unit corresponding one-to-one to a virtual machine to be monitored created by the host, and is configured to generate a corresponding interrupt signal in response to the trigger instruction; and obtaining, by a kernel-mode driver of the virtual machine to be monitored in response to the interrupt signal output by the virtualization monitoring unit, memory statistical data of the virtual machine to be monitored, and the memory statistical data represents a statistical indicator for a memory reclamation process of the virtual machine to be monitored; and obtaining a memory pressure category according to the memory statistical data of the virtual machine to be monitored.

In a second aspect, an embodiment of the present disclosure provides a memory pressure detection apparatus for a virtual machine, including:
a trigger module, configured to send, by a memory monitoring process running in a host, a trigger instruction to a virtualization monitoring unit, and the virtualization monitoring unit corresponding one-to-one to a virtual machine to be monitored created by the host, and is configured to generate a corresponding interrupt signal in response to the trigger instruction;
a detection module, configured to obtain, by a kernel-mode driver of the virtual machine to be monitored in response to the interrupt signal output by the virtualization monitoring unit, memory statistical data of the virtual machine to be monitored, and the memory statistical data represents a statistical indicator for a memory reclamation process of the virtual machine to be monitored; and
a processing module, configured to obtain a memory pressure category according to the memory statistical data of the virtual machine to be monitored.

In a third aspect, an embodiment of the present disclosure provides an electronic device, including: a processor and a memory;
where the memory stores a computer-executable instruction; and
the processor executes the computer-executable instruction stored in the memory, to enable the at least one processor to execute the memory pressure detection method for a virtual machine according to the above first aspect and various possible designs of the first aspect.

In a fourth aspect, an embodiment of the present disclosure provides a computer-readable storage medium, where the computer-readable storage medium stores a computer-executable instruction, and when a processor executes the computer-executable instruction, causing the processor to perform the memory pressure detection method for a virtual machine according to the above first aspect and various possible designs of the first aspect.

In a fifth aspect, an embodiment of the present disclosure provides a computer program product, including a computer program, where when the computer program is executed by a processor, causing the processor to perform the memory pressure detection method for a virtual machine according to the above first aspect and various possible designs of the first aspect.

### BRIEF DESCRIPTION OF THE DRAWINGS

In order to more clearly describe the technical solutions in the embodiments of the present disclosure or in the prior art, the following briefly introduces the drawings required for describing the embodiments or the prior art. Apparently, the drawings in the following description show some embodiments of the present disclosure, and for those of ordinary skill in the art, other drawings may also be obtained from these drawings without creative efforts.

FIG. 1 is a diagram of an application scenario of a memory pressure detection method for a virtual machine according to an embodiment of the present disclosure;

FIG. 2 is a first flowchart of a memory pressure detection method for a virtual machine according to an embodiment of the present disclosure;

FIG. 3 is a schematic diagram of a process of obtaining memory statistical data by a host according to an embodiment of the present disclosure;

FIG. 4 is a flowchart of a specific implementation of step S102 in the embodiment shown in FIG. 2;

FIG. 5 is a flowchart of a specific implementation of step S103 in the embodiment shown in FIG. 2;

FIG. 6 is a flowchart of another specific implementation of step S103 in the embodiment shown in FIG. 2;

FIG. 7 is a flowchart of yet another specific implementation of step S103 in the embodiment shown in FIG. 2;

FIG. 8 is a second flowchart of a memory pressure detection method for a virtual machine according to an embodiment of the present disclosure;

FIG. 9 is a block diagram of a structure of a memory pressure detection apparatus for a virtual machine according to an embodiment of the present disclosure;

FIG. 10 is a schematic diagram of a structure of an electronic device according to an embodiment of the present disclosure; and

FIG. 11 is a schematic diagram of a hardware structure of an electronic device according to an embodiment of the present disclosure.

### DETAILED DESCRIPTION OF EMBODIMENTS

In order to make the objectives, technical solutions and advantages of the embodiments of the present disclosure clearer, the technical solutions in the embodiments of the present disclosure are clearly and comprehensively described below with reference to the drawings in the embodiments of the present disclosure. Apparently, the described embodiments are merely a part of the embodiments of the present disclosure, but not all of the embodiments. Based on the embodiments in the present disclosure, all other embodiments obtained by those of ordinary skill in the art without creative efforts shall fall within the protection scope of the present disclosure.

It should be noted that user information (including but not limited to user device information, user personal information, etc.) and data (including but not limited to data for analysis, stored data, displayed data, etc.) involved in the present disclosure are information and data authorized by users or fully authorized by parties, and collection, use, and processing of related data need to comply with relevant laws, regulations, and standards in relevant countries and regions, and provide corresponding operation entry for users to choose authorization or rejection.

At the same time, when a memory reclamation process is too drastic, it may cause a freeze of the system, that is, a memory jitter (bumping) phenomenon. In the existing technologies, in view of a feature that a memory reclamation process is uncontrollable, a dedicated memory monitoring program is usually deployed in a virtual machine to monitor a memory usage of the virtual machine to avoid the above-mentioned memory jitter problem.

However, in a practical application process, after the memory reclamation mechanism of the system is triggered, the system may also close the memory detection program running in the virtual machine, thereby causing a problem that the memory pressure of the virtual machine cannot be detected.

The following explains the application scenarios of the embodiments of the present disclosure:

The memory pressure detection method for a virtual machine provided in the embodiments of the present disclosure can be applied to an application scenario of memory monitoring of a virtual machine. An execution body of this embodiment may be a host that creates a virtual machine (Guest), or other electronic devices that perform similar functions. In some embodiments, a server can implement the memory pressure detection method for a virtual machine provided in the embodiments of the present application by running various computer-executable instructions or a computer program. For example, the computer-executable instruction may be a program-level command, a machine instruction, or a software instruction. The computer program may be a native program or a software module in an operating system, or may be a local application, that is, a program that needs to be installed in the operating system to run. In conclusion, the above-mentioned computer-executable instruction may be an instruction in any form, and the above-mentioned computer program may be an application, a module, or a plug-in in any form, and a specific implementation form may be configured as required. Further, in some embodiments, the server may be an independent physical server, or may be a server cluster or a distributed system composed of multiple physical servers, or may be a cloud server that provides basic cloud computing services such as cloud services, cloud storage, cloud communication, cloud database, cloud computing, cloud functions, network services, middleware services, domain name services, security services, content delivery network (Content Delivery Network, CDN), and big data and artificial intelligence platforms, where the cloud service may be an interactive processing service for a terminal device to call.

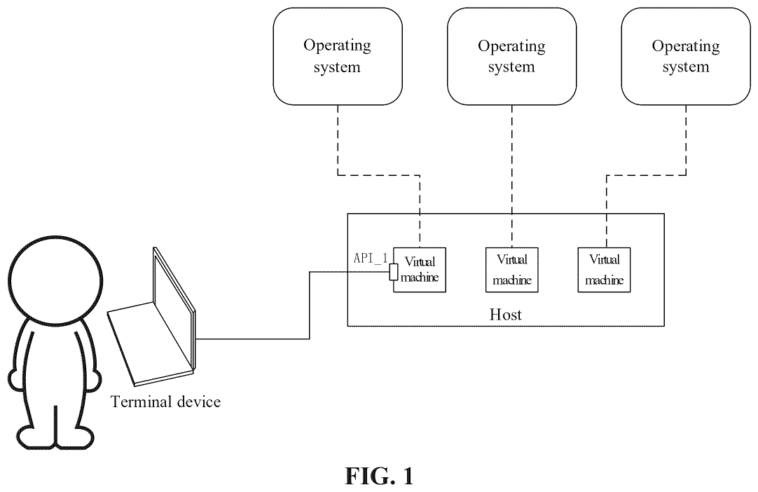

FIG. 1 is a diagram of an application scenario of a memory pressure detection method for a virtual machine according to an embodiment of the present disclosure. Referring to FIG. 1, the host creates, configures, and manages a plurality of independent virtual machines by running a virtual machine monitor (VMM), and provides corresponding physical resources for the virtual machines, such as a CPU resource and a memory resource. A corresponding operating system independently runs on each virtual machine, and the operating system has a memory management function, that is, performs memory allocation and reclamation according to a currently running program and service of the virtual machine to ensure normal running of the program on the virtual machine. At the same time, the operating system provides a corresponding memory monitoring interface (API_1) to the outside, and other terminal devices (for example, terminal devices used by a user who uses or maintains the virtual machine) can call the monitoring interface to implement monitoring of the memory pressure of the virtual machine.

In the existing technologies, when the memory pressure of the virtual machine is too high, the memory reclamation mechanism of the operating system is triggered to reduce the memory pressure of the virtual machine. However, the memory reclamation mechanism of the operating system has a certain uncontrollability. In some cases, the memory reclamation mechanism of the operating system may also close the memory detection program running in the virtual machine, thereby causing that the external terminal device cannot obtain the current memory state of the virtual machine through, for example, the above-mentioned memory monitoring interface, and then causing a problem that the memory pressure of the virtual machine cannot be detected, which affects the running stability and performance of the virtual machine.

An embodiment of the present disclosure provides a memory pressure detection method for a virtual machine to solve the above problem.

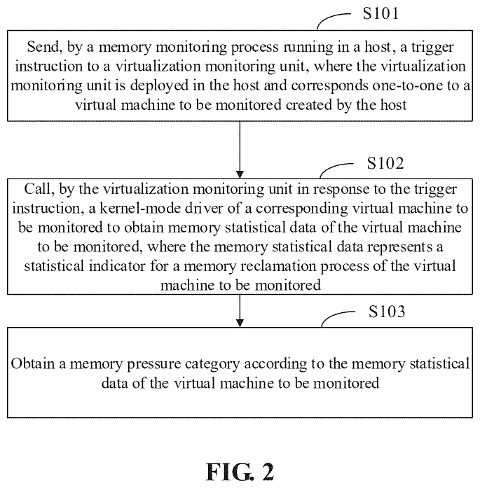

Referring to FIG. 2, FIG. 2 is a flowchart of a memory pressure detection method for a virtual machine according to an embodiment of the present disclosure. The method of this embodiment can be applied to the host, and the memory pressure detection method for a virtual machine includes the following steps.
Step S101: sending, by a memory monitoring process running in the host, a trigger instruction to a virtualization monitoring unit, where the virtualization monitoring unit is deployed in the host and corresponding one-to-one to a virtual machine to be monitored created by the host.
Step S102: calling, by the virtualization monitoring unit and in response to the trigger instruction, a kernel-mode driver of the corresponding virtual machine to be monitored, to obtain memory statistical data of the virtual machine to be monitored, and the memory statistical data represents a statistical indicator for a memory reclamation process of the virtual machine to be monitored.

Exemplarily, referring to the schematic diagram of the application scenario shown in FIG. 1, the host creates one or more virtual machines in a manner of sharing hardware resources by running a virtual machine monitor, and allocates corresponding computing resources for each virtual machine. The creation principle and specific process of the virtual machine are the existing technologies known to those skilled in the art, and will not be repeated here. After the virtual machine is created, a process for monitoring a memory pressure of each virtual machine, that is, a memory monitoring process, runs in the host. The memory monitoring process may be started after the host is initialized and always maintained, so as to trigger the virtualization detection unit corresponding to each virtual machine created by the host in a polling manner, thereby implementing a purpose of obtaining the memory pressure corresponding to each virtual machine.

Specifically, the memory monitoring process corresponds to a memory monitoring program preset in the host, and a process is created to execute the memory monitoring program, thereby implementing the purpose of sending the trigger instruction to the virtualization monitoring unit. The memory monitoring process may send the trigger instruction to each virtualization monitoring unit based on a fixed period, or may send the trigger instruction to each virtualization monitoring unit based on other trigger conditions, which is not limited in this embodiment, according to specific program logic of the memory monitoring program preset in the host corresponding to the memory monitoring process.

Furthermore, the virtualization monitoring unit is a functional module deployed in the virtual machine and used for obtaining the memory pressure of the virtual machine, and may be maintained in the memory of the host by a specific process. The virtualization monitoring unit corresponding one-to-one to the virtual machine created by the host. For example, if the host creates 100 virtual machines, 100 virtualization monitoring units are correspondingly deployed in the host. After receiving the trigger instruction sent by the memory monitoring process, the virtualization monitoring unit calls the kernel-mode driver of the corresponding virtual machine to obtain the memory statistical data of the virtual machine to be monitored. The kernel-mode driver of the virtual machine refers to a driver running in the kernel mode of the virtual machine, and has a high-level permission for the virtual machine, that is, the storage statistical data of the virtual machine may be obtained by the driver.

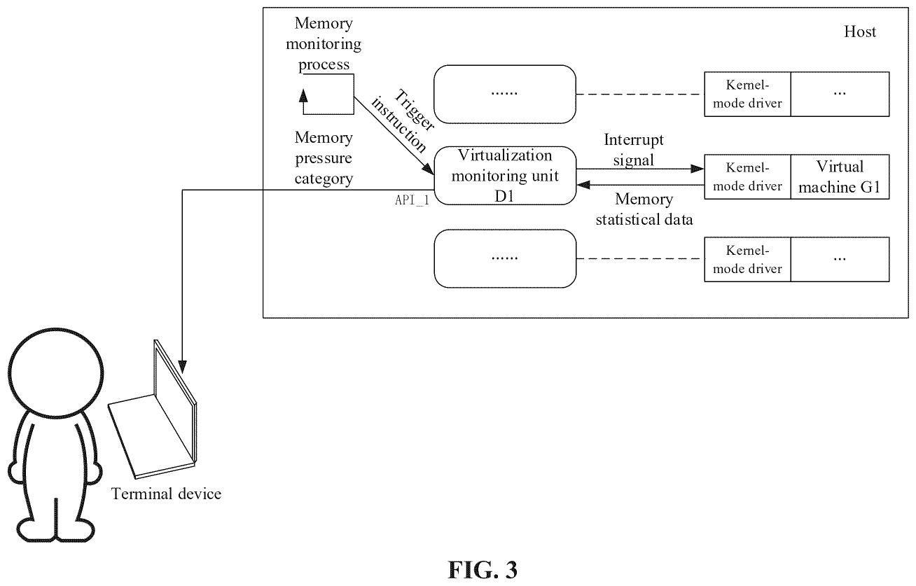

More specifically, the kernel-mode driver of the virtual machine to be monitored can respond to the request sent by the virtualization monitoring unit, for example, an interrupt request, to obtain the memory statistical data of the virtual machine, and send the memory statistical data to the virtualization monitoring unit. FIG. 3 is a schematic diagram of a process of obtaining memory statistical data by the host according to an embodiment of the present disclosure. As shown in FIG. 3, exemplarily, first, the memory monitoring process in the host sends a trigger instruction for the virtual machine G1 to the virtualization monitoring unit D1. After receiving the trigger instruction, the virtualization monitoring unit D1 sends an interrupt signal to call the kernel-mode driver of the virtual machine G1 to obtain the memory statistical data corresponding to the virtual machine G1. Then, the memory statistical data is sent back to the virtualization monitoring unit D1, and the virtualization monitoring unit D1 completes a subsequent step of calculating the memory pressure category. Further, when it is necessary to push the memory pressure category obtained through the subsequent calculation to an external interrupt device, it may also be implemented by the virtualization monitoring unit in the host. For example, the terminal device obtains the memory pressure category corresponding to the virtual machine G1 by accessing an interface API_1 provided by the virtualization monitoring unit D1 in the figure, or pushes the memory pressure category corresponding to the virtual machine G1 to the terminal device through the interface API_1 provided by the virtualization monitoring unit D1.

Based on the introduction of the above embodiment, after obtaining the memory statistical data, the virtualization monitoring unit processes the memory statistical data outside the virtual machine to obtain the memory pressure category, thereby completing the objective of the memory pressure detection. This process is completed outside the virtual machine, without the need to maintain a monitoring process inside the virtual machine for the memory pressure detection, therefore avoiding the problem that the memory pressure detection process in the virtual machine is closed during the memory reclamation process.

In a possible implementation, before the memory statistical data of the virtual machine to be monitored is obtained by calling the kernel-mode driver of the corresponding virtual machine to be monitored, the method further includes a step of initializing the kernel-mode driver. Specifically, the method includes the following step.
Step S100A: initializing the kernel-mode driver of the virtual machine to be monitored to generate a program parameter corresponding to the virtual machine to be monitored, where the program parameter is used to indicate a category of the statistical indicator corresponding to the memory statistical data.
Step S100B: creating a monitoring program object and a communication program object according to the program parameter.

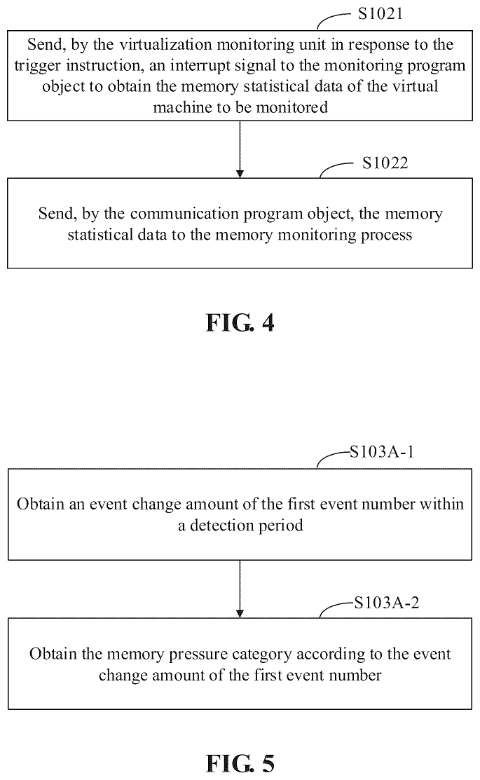

Correspondingly, as shown in FIG. 4, after the above step is performed, the specific implementation of step S102 includes the following steps.
Step S1021: sending, by the virtualization monitoring unit and in response to the trigger instruction, an interrupt signal to the monitoring program object to obtain the memory statistical data of the virtual machine to be monitored.
Step S1022: sending, by the communication program object, the memory statistical data to the memory monitoring process.

Exemplarily, the kernel-mode driver, as a driver of the virtual machine to be monitored, needs to be initialized before being used. For example, in the process of creating the virtual machine to be monitored, the kernel-mode driver thereof is initialized, which includes generating a program parameter corresponding to the virtual machine to be monitored, and the program parameter is used to indicate the category of the statistical indicator corresponding to the memory statistical data. Specifically, the program parameter is a parameter related to the virtual machine, and in the process of creating the virtual machine, the virtual machine is configured according to the use of the virtual machine, which further causes the kernel-mode driver to have corresponding and possible different program parameters after being initialized. The different program parameters indicate the category of the statistical indicator corresponding to the memory statistical data, that is, the specific implementation of the statistical indicator in the memory reclamation process. For example, for the virtual machine G1, after the kernel-mode driver thereof is initialized according to its configuration information, the program parameter para_1 is generated, and accordingly, according to the program parameter, the memory statistical data composed of the statistical indicator A, the statistical indicator B, and the statistical indicator C in the memory reclamation process of the virtual machine is detected subsequently. For the virtual machine G2, after the kernel-mode driver thereof is initialized according to its configuration information, the program parameter para_2 is generated, and accordingly, according to the program parameter, the memory statistical data composed of the statistical indicator B, the statistical indicator C, and the statistical indicator E in the memory reclamation process of the virtual machine is detected subsequently.

Further, after the program parameter corresponding to the virtual machine to be monitored is generated, the monitoring program object and/or the communication program object are created based on the program parameter, and the monitoring program object is used to obtain the memory statistical data, and the communication program object is used to transmit the memory statistical data. Then, when the kernel-mode driver of the corresponding virtual machine to be monitored is called, the virtualization monitoring unit sends the interrupt signal to the monitoring program object, and after receiving the interrupt signal, the monitoring program object obtains the memory statistical data corresponding to the virtual machine to be monitored according to the program parameter used when the monitoring program object is created (that is, the corresponding monitoring program object is created according to the different program parameters to obtain the corresponding memory statistical data). Then, the memory statistical data is returned to the virtualization monitoring unit by the communication program object.

It may be understood that the above-mentioned communication program object and the monitoring program object are two specific implementations for implementing the obtaining of the memory statistical data and the return of the memory statistical data, and there may be other implementations for implementing the obtaining of the memory statistical data and the return of the memory statistical data. Therefore, the step of creating the communication program object and the monitoring program object may be performed selectively or simultaneously as required, which is not limited in this embodiment.

Further, the memory statistical data involved in the steps of the above embodiment is further introduced below. The memory statistical data refers to a statistical indicator in a process of reclaiming data in the memory and reclaiming the memory resource by the operating system of the virtual machine to be monitored based on the memory reclamation mechanism. The memory statistical data includes, for example, any one or more of the following:
a first event number, a second event number, a third event number, a first number of scanned pages, a second number of scanned pages, a first number of reclaimed pages, and a second number of reclaimed pages.

The first event number represents a number of occurrence of an out-of-memory (OOM) event. The second event number represents a number of occurrence of a missing page fault event. The third event number represents a number of occurrence of a direct memory reclamation event. The first number of scanned pages represents a number of memory pages scanned by a reclamation thread in a background memory reclamation event. The second number of scanned pages represents a number of memory pages scanned by a reclamation thread in a direct memory reclamation event. The first number of reclaimed pages represents a number of reclaimed memory pages in a background memory reclamation event. The second number of reclaimed pages represents a number of reclaimed memory pages in a direct memory reclamation event. The above-mentioned statistical indicators of the virtual machine in the memory reclamation process may be used as features representing a current memory running state of the virtual machine. By processing the above-mentioned statistical indicators, an purpose of predicting the memory pressure category may be implemented.
Step S103: obtaining a memory pressure category according to the memory statistical data of the virtual machine to be monitored.

Exemplarily, after obtaining the above-mentioned memory statistical data, the memory statistical data of the virtual machine to be monitored is analyzed outside the virtual machine, so that the current memory pressure of the virtual machine to be monitored may be classified, thereby obtaining the memory pressure category. This arrangement may be executed by the virtualization monitoring unit, or may be executed by the memory monitoring process calling other functional units, which may be specifically set as required, and will not be repeated in this embodiment. Since this execution process is executed by the independent functional unit in the host, instead of the monitoring program inside the virtual machine, it is possible to avoid a problem that the memory pressure of the virtual machine cannot be detected due to the memory monitoring program being accidentally closed when the memory pressure of the virtual machine is relatively high.

Exemplarily, the process of obtaining the memory pressure category is described in detail below with reference to the implementations of the above-mentioned memory statistical data. For example, if the change amount of the first event number is greater than 0, it means that the number of occurrences of the out-of-memory event increases, that is, an out-of-memory event has occurred recently, which may be regarded as a very serious (high-level) memory pressure category. For another example, if the change amount of the third event number is greater than a specific threshold, it means that a relatively serious memory shortage occurs, which may affect the performance of the virtual machine, and it may be regarded as a relatively serious (medium-high level) memory pressure category. By analogy, by analyzing the above-mentioned statistical indicators, different memory pressure categories may be obtained.

In a possible implementation, as shown in FIG. 5, the memory statistical data includes the first event number, and the specific implementation of step S103 includes the following steps.
Step S103A-1: obtaining an event change amount of the first event number within a detection period.
Step S103A-2: obtaining the memory pressure category according to the event change amount of the first event number.

Exemplarily, the event change amount of the first event number is the change amount of the number of occurrences of the out-of-memory event. Specifically, the memory monitoring process sends the trigger instruction to the virtualization monitoring unit through a specific detection period, and obtains the event change amount by counting the number of occurrences of the out-of-memory event in each detection period and comparing it with the number of occurrences of the out-of-memory event in the previous detection period. For example, according to the first event number, the number of occurrences of the out-of-memory event recorded in the system in the t(1) period is N. If the number of occurrences of the out-of-memory event recorded in the system in the t(2) period is still N, the event change amount is 0, indicating that no out-of-memory event occurs in the t(2) period. If the number of occurrences of the out-of-memory event recorded in the system in the t(2) period is M (M>N), the event change amount is greater than or equal to 1. At this time, it means that an out-of-memory event occurs in the t(2) period, and then the corresponding memory pressure category may be determined according to whether the out-of-memory event occurs or according to the number of occurrences of the out-of-memory event (i.e., the event change amount). For example, within a certain value range, the greater the event change amount is, the greater the memory pressure is, and the more serious the corresponding memory pressure category is.

Further, exemplarily, the specific implementation of step S103A-2 includes the following steps.
Step S103A-21: if the event change amount of the first event number is greater than a first threshold, obtaining a first-level pressure category.
Step S103A-22: if the event change amount of the first event number is less than the first threshold, obtaining an event change amount of a third event number, and if the event change amount of the third event number is greater than a second threshold, obtaining a second-level pressure category.

In the case corresponding to step S103A-21, the first threshold may be equal to 0, and in consideration of errors and other accidental situations, the first threshold may also be other values greater than 0, which has been introduced in the previous part and will not be repeated here. For the case corresponding to step S103A-22, in the case that the event change amount of the first event number is less than the first threshold, that is, in the case that the out-of-memory event does not occur (or only a very small number of out-of-memory events occur), the determination may be further performed by obtaining the event change amount of the third event number, that is, if the event change amount of the third event number is greater than the second threshold, the second-level pressure category is obtained. The third event represents the number of occurrences of the direct memory reclamation event, and the second-level pressure category may be, for example, a relatively serious (that is, a category that is less serious than the first-level pressure category and more serious than the third-level pressure category) pressure category. The second threshold may be a threshold that is pre-configured and matches the performance specification of the virtual machine, and the specific data thereof may be set as required.

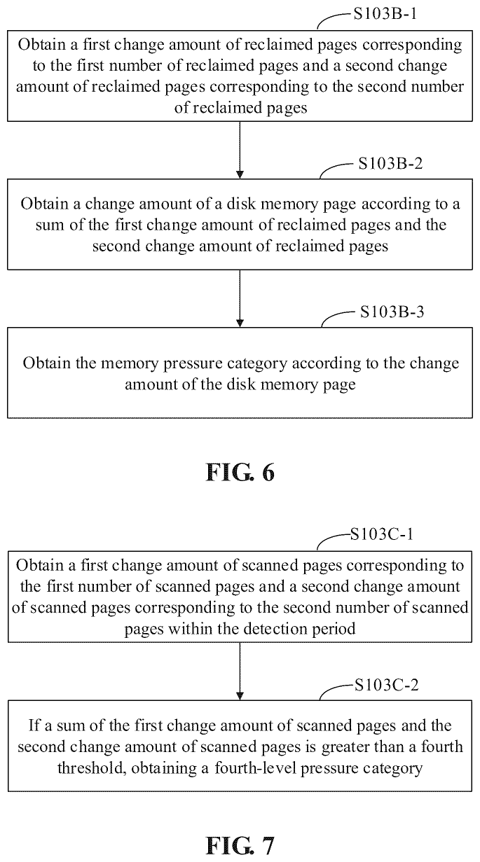

In another possible implementation, as shown in FIG. 6, the memory statistical data includes the first number of reclaimed pages and the second number of reclaimed pages, and the specific implementation of step S103 includes the following steps.
Step S103B-1: obtaining a first change amount of reclaimed pages corresponding to the first number of reclaimed pages and a second change amount of reclaimed pages corresponding to the second number of reclaimed pages.
Step S103B-2: obtaining a change amount of a disk memory page according to a sum of the first change amount of reclaimed pages and the second change amount of reclaimed pages.
Step S103B-3: obtaining the memory pressure category according to the change amount of the disk memory page.

Exemplarily, in this embodiment, the memory statistical data includes the first number of reclaimed pages and the second number of reclaimed pages, where the first number of reclaimed pages represents the number of reclaimed memory pages in the background memory reclamation event, and the second number of reclaimed pages represents the number of reclaimed memory pages in the direct memory reclamation event. Specifically, in a Linux system, the background memory reclamation event corresponds to a memory reclamation event performed by a kswapd thread, and the first number of reclaimed pages is the number of memory pages (page) scanned in the memory reclamation process performed by the kswapd thread. The direct memory reclamation event is a memory reclamation event triggered when a reclamation rate of the kswapd thread is lower than a memory allocation rate of a user process or when an available memory amount is lower than a minimum memory watermark. The above two memory reclamation manners are the existing technologies known to those skilled in the art, and will not be repeated here. After the virtual machine has the above-mentioned background memory reclamation event and the direct memory reclamation event, the system records corresponding statistical data, that is, the first number of reclaimed pages and the second number of reclaimed pages. After obtaining the first number of reclaimed pages and the second number of reclaimed pages, the host calculates corresponding change amounts, that is, the first change amount of reclaimed pages corresponding to the first number of reclaimed pages and the second change amount of reclaimed pages corresponding to the second number of reclaimed pages. The calculation manner of the change amount has been introduced in the previous embodiment, and reference may be made to the calculation manner of the event change amount of the first event number, which will not be repeated here. Then, the change amount of the disk memory page is obtained according to the sum of the first change amount of reclaimed pages and the second change amount of reclaimed pages. Finally, the corresponding memory pressure category is determined according to the condition of the change amount of the disk memory page and based on a preset mapping table.

Further, in a possible implementation, the specific implementation of step S103B-3 includes the following steps.
Step S103B-31: obtaining a reclaimed disk bandwidth according to the change amount of the disk memory page and a size of the disk memory page.
Step S103B-32: if a ratio of the reclaimed disk bandwidth to a system disk bandwidth is greater than a third threshold, obtaining a third-level pressure category.

Exemplarily, the size of the disk memory page (pagesize) is the memory space occupied by each memory page, and the total memory reclamation amount, that is, the reclaimed disk bandwidth, may be obtained by calculating the product of the change amount of the disk memory page and the size of the disk memory page. Then, a ratio of the reclaimed disk bandwidth to the system disk bandwidth is obtained, that is, a ratio value of the reclaimed bandwidth is obtained, and the ratio value represents the reclamation volatility, that is, the greater the ratio of the reclaimed disk bandwidth to the system disk bandwidth is, the greater the memory fluctuation caused by the memory reclamation is, and vice versa. Finally, by comparing the ratio of the reclaimed disk bandwidth to the system disk bandwidth with the preset third threshold, if the ratio of the reclaimed disk bandwidth to the system disk bandwidth is greater than or equal to the third threshold, the memory pressure level is determined as the third-level pressure category.

In yet another possible implementation, the memory statistical data includes the first number of scanned pages and the second number of scanned pages. As shown in FIG. 7, the memory statistical data includes the first number of reclaimed pages and the second number of reclaimed pages, and the specific implementation of step S103 includes the following steps.
Step S103C-1: obtaining a first change amount of scanned pages corresponding to the first number of scanned pages and a second change amount of scanned pages corresponding to the second number of scanned pages within the detection period.
Step S103C-2: if a sum of the first change amount of scanned pages and the second change amount of scanned pages is greater than a fourth threshold, obtaining a fourth-level pressure category.

Exemplarily, the steps of this embodiment provide yet another implementation of determining the memory pressure category. Specifically, the first change amount of scanned pages and the second number of scanned pages respectively represent the number of memory pages scanned by the reclamation thread in the background memory reclamation event and the number of memory pages scanned by the reclamation thread in the direct memory reclamation event. In the previous embodiment, the concepts of the background memory reclamation event and the direct memory reclamation event have been introduced. In the steps of this embodiment, the number of memory pages scanned by the thread in the background memory reclamation event and the number of memory pages scanned by the thread in the direct memory reclamation event are obtained, and the sum of the two is calculated to obtain a total change amount of the scanned pages, and the total change amount of the scanned pages represents the number of memory pages scanned in the memory reclamation process. The greater the total change amount of the scanned pages is, the more drastic the memory reclamation process is, and then the performance fluctuation of the virtual machine is more serious. When the total change amount of the scanned pages is greater than the fourth threshold, the corresponding memory pressure category is determined as the fourth-level pressure category.

Further, in another possible implementation, the memory statistical data includes the second event number, and the second event number represents the number of occurrences of a missing page fault event (major page fault). Similarly, the number of occurrences of the missing page fault event is determined by obtaining the third event number and calculating the corresponding event change amount. The higher the event change amount of the third event number is, the more serious the situation of the memory resource shortage is. Therefore, if the event change amount of the second event number is greater than a fifth threshold, it may be determined that a serious memory resource shortage has occurred recently, and then the memory pressure category is determined as the fifth-level pressure category.

In this embodiment, the trigger instruction is sent to the virtualization monitoring unit by the memory monitoring process running in the host, where the virtualization monitoring unit corresponding one-to-one to the virtual machine to be monitored created by the host, and is configured to generate the corresponding interrupt signal in response to the trigger instruction. The memory statistical data of the virtual machine to be monitored is obtained by the kernel-mode driver of the virtual machine to be monitored in response to the interrupt signal output by the virtualization monitoring unit, the memory statistical data representing the statistical indicator for the memory reclamation process of the virtual machine to be monitored. The memory pressure category is obtained according to the memory statistical data of the virtual machine to be monitored. The virtualization monitoring unit corresponding one-to-one to the virtual machine to be monitored is set in the host, and the interrupt signal is sent to the kernel-mode driver of the virtual machine to be monitored through the virtualization monitoring unit, so as to obtain the memory statistical data, and then the memory pressure category is obtained based on the memory statistical data, to implement detection of the memory pressure. Since the above steps are performed outside the virtual machine, and the memory pressure detection is not performed by depending on the memory detection program running in the virtual machine, it is possible to avoid a problem that the memory pressure of the virtual machine cannot be detected due to the memory reclamation mechanism causing the memory detection program to be closed, thereby improving the stability and reliability of the memory detection of the virtual machine.

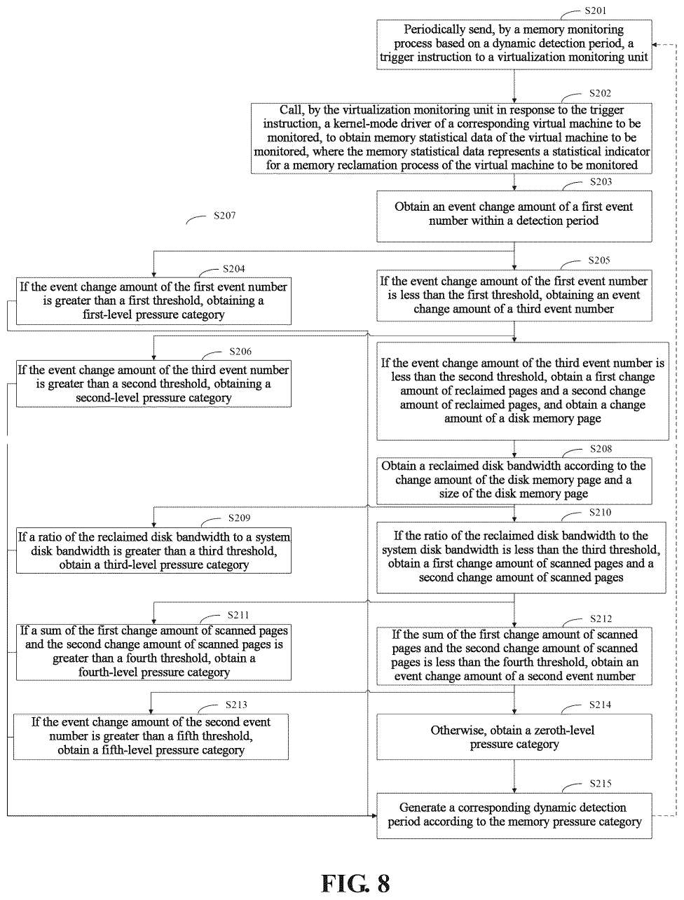

Referring to FIG. 8, FIG. 8 is a second flowchart of a memory pressure detection method for a virtual machine according to an embodiment of the present disclosure. This embodiment further refines step S103 on the basis of the embodiment shown in FIG. 2, and the memory pressure detection method for a virtual machine includes the following steps.
Step S201: periodically sending, by a memory monitoring process based on a dynamic detection period, a trigger instruction to a virtualization monitoring unit.
Step S202: calling, by the virtualization monitoring unit and in response to the trigger instruction, a kernel-mode driver of a corresponding virtual machine to be monitored, to obtain memory statistical data of the virtual machine to be monitored, the memory statistical data representing a statistical indicator for a memory reclamation process of the virtual machine to be monitored.
Step S203: obtaining an event change amount of a first event number within a detection period.
Step S204: if the event change amount of the first event number is greater than a first threshold, obtaining a first-level pressure category.
Step S205: if the event change amount of the first event number is less than the first threshold, obtaining an event change amount of a third event number.
Step S206: if the event change amount of the third event number is greater than a second threshold, obtaining a second-level pressure category.
Step S207: if the event change amount of the third event number is less than the second threshold, obtaining a first change amount of reclaimed pages corresponding to the first number of reclaimed pages and a second change amount of reclaimed pages corresponding to the second number of reclaimed pages, and obtaining a change amount of a disk memory page according to a sum of the first change amount of reclaimed pages and the second change amount of reclaimed pages.
Step S208: obtaining a reclaimed disk bandwidth according to the change amount of the disk memory page and a size of the disk memory page.
Step S209: if a ratio of the reclaimed disk bandwidth to a system disk bandwidth is greater than a third threshold, obtaining a third-level pressure category.
Step S210: if the ratio of the reclaimed disk bandwidth to the system disk bandwidth is less than the third threshold, obtaining a first change amount of scanned pages corresponding to the first number of scanned pages and a second change amount of scanned pages corresponding to the second number of scanned pages within the detection period.
Step S211: if a sum of the first change amount of scanned pages and the second change amount of scanned pages is greater than a fourth threshold, obtaining a fourth-level pressure category.
Step S212: if the sum of the first change amount of scanned pages and the second change amount of scanned pages is less than the fourth threshold, obtaining an event change amount of a second event number.
Step S213: if the event change amount of the second event number is greater than a fifth threshold, obtaining a fifth-level pressure category.
Step S214: otherwise, obtaining a zeroth-level pressure category.

Exemplarily, this embodiment provides a solution for performing memory pressure detection based on a memory pressure priority. After the memory statistical data is obtained by the virtualization monitoring unit, the memory pressure category is accurately obtained through sequential determination according to the priorities of the respective statistical indicators in the memory statistical data of the virtual machine to be monitored. Specifically, first, the determination is performed according to the statistical indicator with the highest priority in the memory statistical data, that is, the first event number representing the number of occurrences of the out-of-memory event. If the condition of the first-level pressure category is satisfied according to the first event number, the memory pressure category is determined as the first-level pressure category, and the memory pressure detection in this period ends. Then, if the condition of the first-level pressure category is satisfied, the memory pressure category is detected according to the statistical indicator with the next priority, and so on, until a specific memory pressure category is determined. Through the above solution of this embodiment, that is, the memory pressure category is sequentially judged based on the priorities of the respective statistical indicators in the memory statistical data, and in a case that there is a relatively serious memory pressure, the memory detection process ends in advance, and the corresponding memory pressure category is output, which can improve the efficiency and timeliness of the memory pressure detection.

The specific implementation process of determining the first-level pressure category to the fifth-level pressure category in the above steps has been described in detail in the embodiment shown in FIG. 2, and will not be repeated here. The zeroth-level pressure category may represent a case that the memory pressure is relatively slight in the current detection period, and the memory pressure may not be processed or intervened. At the same time, it should be noted that in this embodiment, in the process of comparing the respective thresholds (the first threshold to the fifth threshold) to determine the corresponding memory pressure category, the boundary determination condition (the case of equal) may be flexibly set as required. For example, when the event change amount of the first event number is equal to the first threshold, the step of obtaining the first-level pressure category in step S204 may be performed, or the step of obtaining the event change amount of the third event number in step S205 may be performed. The case of the boundary point will not be illustrated and repeated here.

Optionally, after obtaining the specific memory pressure category, for example, after performing any of steps S204, S206, S208, S210, and S212, the method further includes the following step.
Step S215: generating a corresponding dynamic detection period according to the memory pressure category, and the dynamic detection period is used to control a frequency of sending the trigger instruction to the virtualization monitoring unit by the memory monitoring process.

Exemplarily, after performing any of steps S204, S206, S208, S210, and S212, the corresponding dynamic detection period may be further generated according to the obtained memory pressure category. Then, step S201 is returned to and performed, and the memory pressure of the virtual machine continues to be detected based on the dynamic detection period. Since the detection period is related to the resource overhead, the shorter the detection period is, the shorter the resource overhead of the host for the above memory pressure detection process is. Therefore, in this embodiment, the corresponding detection period is adjusted in real time according to the memory pressure detection result of the current round to obtain the dynamic detection period, and the frequency of sending the trigger instruction to the virtualization monitoring unit by the memory monitoring process is controlled according to the dynamic detection period. Then, the next round of memory monitoring is performed based on the dynamic detection period. When the memory pressure is relatively small, the detection period is extended (the frequency is reduced), and when the memory pressure is relatively large, the detection period is shortened (the frequency is increased), thereby improving the efficiency of using the computing resource in the memory detection process.

In this embodiment, the implementations of steps S201 to S202 are the same as the implementations of steps S101 to S102 in the embodiment shown in FIG. 2 of the present disclosure, and will not be repeated here.

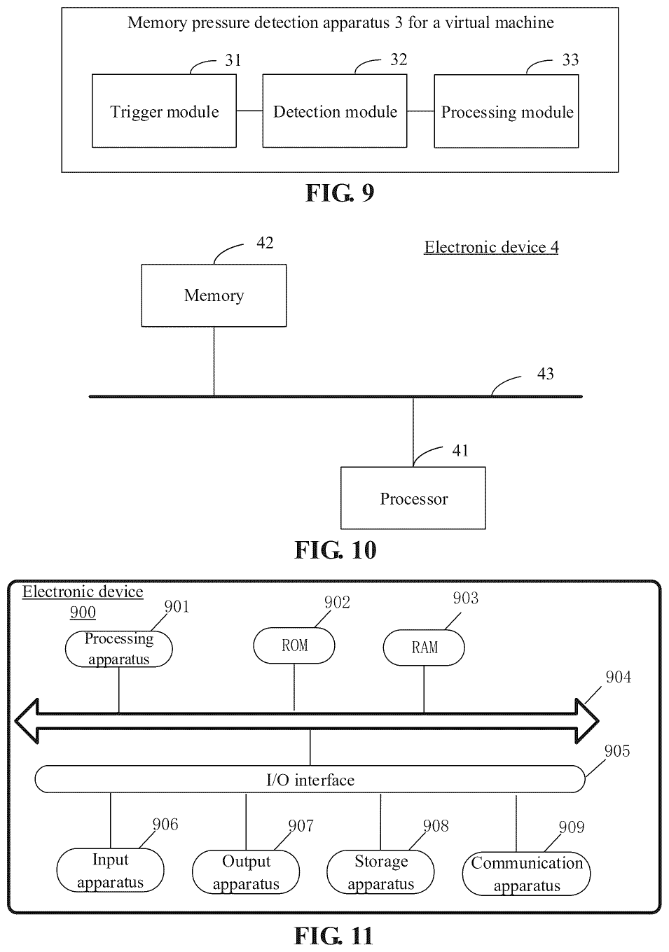

Corresponding to the memory pressure detection method for a virtual machine in the above embodiment, FIG. 9 is a block diagram of a structure of a memory pressure detection apparatus for a virtual machine according to an embodiment of the present disclosure. The method introduced in the above embodiment may be executed by the memory pressure detection apparatus for a virtual machine, and the apparatus may be implemented in a software and/or hardware manner. The apparatus may be integrated in an electronic device with a certain data processing function. The electronic device may include, but is not limited to, a mobile terminal with a large data processing capability, and a fixed terminal with a large data processing capability such as a desktop computer and a super computer.

For ease of illustration, only parts related to the embodiments of the present disclosure are shown. Referring to FIG. 9, the memory pressure detection apparatus 3 for a virtual machine includes:
a trigger module 31, configured to send, by a memory monitoring process running in a host, a trigger instruction to a virtualization monitoring unit, and the virtualization monitoring unit corresponding one-to-one to a virtual machine to be monitored created by the host, and is configured to generate a corresponding interrupt signal in response to the trigger instruction;
a detection module 32, configured to obtain, by a kernel-mode driver of the virtual machine to be monitored in response to the interrupt signal output by the virtualization monitoring unit, memory statistical data of the virtual machine to be monitored, the memory statistical data representing a statistical indicator for a memory reclamation process of the virtual machine to be monitored; and
a processing module 33, configured to obtain a memory pressure category according to the memory statistical data of the virtual machine to be monitored.

According to one or more embodiments of the present disclosure, after the memory pressure category is obtained according to the memory statistical data of the virtual machine to be monitored, the trigger module 31 is further configured to: generate a corresponding dynamic detection period according to the memory pressure category, and the dynamic detection period is used to control a frequency of sending the trigger instruction to the virtualization monitoring unit by the memory monitoring process. The trigger module 31 is further configured to: periodically send, by the memory monitoring process based on the dynamic detection period, the trigger instruction to the virtualization monitoring unit.

According to one or more embodiments of the present disclosure, before the memory statistical data of the virtual machine to be monitored is obtained by calling the kernel-mode driver of the corresponding virtual machine to be monitored by the virtualization monitoring unit and in response to the trigger instruction, the detection module 31 is further configured to: initialize the kernel-mode driver of the virtual machine to be monitored to generate a program parameter corresponding to the virtual machine to be monitored, where the program parameter is used to indicate a category of the statistical indicator corresponding to the memory statistical data; and create a monitoring program object and a communication program object according to the program parameter. The detection module 31 is further configured to perform at least one of the following: send, by the virtualization monitoring unit and in response to the trigger instruction, an interrupt signal to the monitoring program object to obtain the memory statistical data of the virtual machine to be monitored; and send, by the communication program object, the memory statistical data to the memory monitoring process.

According to one or more embodiments of the present disclosure, the memory statistical data includes at least one of the following: a first event number, a second event number, a third event number, a first number of scanned pages, a second number of scanned pages, a first number of reclaimed pages, and a second number of reclaimed pages. The first event number represents a number of occurrence of out-of-memory events. The second event number represents a number of occurrence of missing page fault events. The third event number represents a number of occurrence of direct memory reclamation events. The first number of scanned pages represents a number of memory pages scanned by a reclamation thread in a background memory reclamation event. The second number of scanned pages represents a number of memory pages scanned by a reclamation thread in a direct memory reclamation event. The first number of reclaimed pages represents a number of reclaimed memory pages in a background memory reclamation event. The second number of reclaimed pages represents a number of reclaimed memory pages in a direct memory reclamation event.

According to one or more embodiments of the present disclosure, the memory statistical data includes the first event number, and the processing module 33 is further configured to: obtain an event change amount of the first event number within a detection period; and obtain the memory pressure category according to the event change amount of the first event number.

According to one or more embodiments of the present disclosure, the memory statistical data further includes the third event number, and the processing module 33 is further configured to: if the event change amount of the first event number is greater than a first threshold, obtain a first-level pressure category; and if the event change amount of the first event number is less than the first threshold, obtain an event change amount of a third event number, and if the event change amount of the third event number is greater than a second threshold, obtain a second-level pressure category.

According to one or more embodiments of the present disclosure, the memory statistical data includes the first number of reclaimed pages and the second number of reclaimed pages, and the processing module 33 is further configured to: obtain a first change amount of reclaimed pages corresponding to the first number of reclaimed pages and a second change amount of reclaimed pages corresponding to the second number of reclaimed pages; obtain a change amount of a disk memory page according to a sum of the first change amount of reclaimed pages and the second change amount of reclaimed pages; and obtain the memory pressure category according to the change amount of the disk memory page.

According to one or more embodiments of the present disclosure, the processing module 33 is further configured to: obtain a reclaimed disk bandwidth according to the change amount of the disk memory page and a size of the disk memory page; and if a ratio of the reclaimed disk bandwidth to a system disk bandwidth is greater than a third threshold, obtain a third-level pressure category.

According to one or more embodiments of the present disclosure, the memory statistical data includes a first number of scanned pages and a second number of scanned pages, and the processing module 33 is further configured to: obtain a first change amount of scanned pages corresponding to the first number of scanned pages and a second change amount of scanned pages corresponding to the second number of scanned pages within a detection period; and if a sum of the first change amount of scanned pages and the second change amount of scanned pages is greater than a fourth threshold, obtain a fourth-level pressure category.

According to one or more embodiments of the present disclosure, the memory statistical data includes a second event number, and the processing module 33 is further configured to: if an event change amount of the second event number is greater than a fifth threshold, obtain a fifth-level pressure category.

The trigger module 31, the detection module 32, and the processing module 33 are sequentially connected. The memory pressure detection apparatus for a virtual machine provided in this embodiment may perform the technical solutions of the above method embodiments, and the implementation principles and technical effects thereof are similar, which will not be repeated in this embodiment.

FIG. 10 is a schematic diagram of a structure of an electronic device according to an embodiment of the present disclosure. As shown in FIG. 10, the electronic device 4 includes:
a processor 41 and a memory 42 in communication connection with the processor 41.

The memory 42 stores computer-executable instructions.

The processor 41 executes the computer-executable instructions stored in the memory 42 to implement the memory pressure detection method for a virtual machine in the embodiments shown in FIG. 2 to FIG. 8.

Optionally, the processor 41 and the memory 42 are connected through a bus 43.

For the related description, reference may be made to the related description and effects corresponding to the steps in the embodiments corresponding to FIG. 2 to FIG. 8 for understanding, which will not be repeated here.

An embodiment of the present disclosure provides a computer-readable storage medium, where the computer-readable storage medium stores computer-executable instructions, and the computer-executable instructions, when executed by a processor, implement the memory pressure detection method for a virtual machine provided in any of the embodiments corresponding to FIG. 2 to FIG. 8 of the present disclosure.

An embodiment of the present disclosure provides a computer program product, including a computer program, where the computer program, when executed by a processor, implements the memory pressure detection method for a virtual machine provided in any of the embodiments corresponding to FIG. 2 to FIG. 8 of the present disclosure.

In order to implement the above embodiments, an embodiment of the present disclosure further provides an electronic device.

Referring to FIG. 11, it shows a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a laptop, a digital broadcast receiver, a personal digital assistant (abbreviated as PDA), a tablet computer, a portable multimedia player (abbreviated as PMP), a vehicle-mounted terminal (such as a vehicle-mounted navigation terminal), and a fixed terminal such as a digital TV, a desktop computer, and the like. The electronic device shown in FIG. 11 is only an example, and should not bring any limitation to the function and usage range of the embodiments of the present disclosure.

As shown in FIG. 11, the electronic device 900 may include a processing apparatus (e.g., a central processing unit, a graphics processing unit, etc.) 901, which may perform various appropriate actions and processing according to a program stored in a read-only memory (abbreviated as ROM) 902 or a program loaded from a storage 908 into a random access memory (abbreviated as RAM) 903. The RAM 903 also stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, a gyroscope, etc.; an output apparatus 907 including, for example, a liquid crystal display (abbreviated as LCD), a speaker, a vibrator, etc.; a storage 908 including, for example, a magnetic tape, a hard disk, etc.; and a communication apparatus 909. The communication apparatus 909 may allow the electronic device 900 to perform wireless or wired communication with other devices to exchange data. Although FIG. 11 shows the electronic device 900 having various apparatuses, it should be understood that it is not required to implement or have all of the illustrated apparatuses. Alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, which includes a computer program carried on a computer-readable medium, and the computer program includes program codes for performing the method shown in the flowchart. In such an embodiment, the computer program may be downloaded and installed from a network through the communication apparatus 909, or installed from the storage 908, or installed from the ROM 902. When the computer program is executed by the processing apparatus 901, the above-mentioned functions defined in the methods of the embodiments of the present disclosure are executed.

It should be noted that the above-mentioned computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier, in which computer-readable program codes are carried. The data signal propagated in this manner may take many forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with the instruction execution system, apparatus, or device. The program codes contained on the computer-readable medium may be transmitted by any suitable medium, including but not limited to: a wire, an optical cable, a radio frequency (RF), etc., or any suitable combination thereof.

The above-mentioned computer-readable medium may be included in the above-mentioned electronic device or may exist alone without being assembled into the electronic device.

The above-mentioned computer-readable medium carries one or more programs, and when the one or more programs are executed by the electronic device, the electronic device is caused to perform the methods shown in the above embodiments.

The computer program codes for performing the operations of the present disclosure may be written in one or more programming languages or a combination thereof, where the above-mentioned programming languages include object-oriented programming languages such as Java, Smalltalk, C++, and also include conventional procedural programming languages such as “C” language or similar programming languages. The program codes may be executed entirely on a user computer, partly on a user computer, as a stand-alone software package, partly on a user computer and partly on a remote computer, or entirely on a remote computer or server. In the scenario related to the remote computer, the remote computer may be connected to the user computer through any type of network, including a local area network (abbreviated as LAN) or a wide area network (abbreviated as WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units or modules involved in the embodiments of the present disclosure may be implemented in a software manner or a hardware manner. The name of the unit or module does not constitute a limitation on the unit itself under certain circumstances.

The functions described herein above may be performed, at least partially, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in conjunction with an instruction execution system, apparatus or device. The machine-readable medium may be a machine-readable signal medium or a machine readable storage medium. The machine-readable medium may include, but is not limited to, an electronic, magnetic, optical, electromagnetic, infrared, or semiconductor system, apparatus or device, or any suitable combination of the foregoing. More specific examples of the machine readable storage medium may include an electrical connection having one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

In a first aspect, according to one or more embodiments of the present disclosure, a memory pressure detection method for a virtual machine is provided, including: sending, by a memory monitoring process running in a host, a trigger instruction to a virtualization monitoring unit, where the virtualization monitoring unit is deployed in the host and corresponding one-to-one to a virtual machine to be monitored created by the host; calling, by the virtualization monitoring unit and in response to the trigger instruction, a kernel-mode driver of a corresponding virtual machine to be monitored to obtain memory statistical data of the virtual machine to be monitored, and the memory statistical data represents a statistical indicator for a memory reclamation process of the virtual machine to be monitored; and obtaining a memory pressure category according to the memory statistical data of the virtual machine to be monitored.

According to one or more embodiments of the present disclosure, after the memory pressure category is obtained according to the memory statistical data of the virtual machine to be monitored, the method further includes: generating a corresponding dynamic detection period according to the memory pressure category, and the dynamic detection period is used to control a frequency of sending the trigger instruction to the virtualization monitoring unit by the memory monitoring process. The sending, by a memory monitoring process running in a host, a trigger instruction to a virtualization monitoring unit includes: periodically sending, by the memory monitoring process based on the dynamic detection period, the trigger instruction to the virtualization monitoring unit.

According to one or more embodiments of the present disclosure, before the memory statistical data of the virtual machine to be monitored is obtained by calling the kernel-mode driver of the corresponding virtual machine to be monitored by the virtualization monitoring unit and in response to the trigger instruction, the method further includes: initializing the kernel-mode driver of the virtual machine to be monitored to generate a program parameter corresponding to the virtual machine to be monitored, where the program parameter is used to indicate a category of the statistical indicator corresponding to the memory statistical data; and creating a monitoring program object and a communication program object according to the program parameter. The obtaining, by the virtualization monitoring unit and in response to the trigger instruction, the memory statistical data of the virtual machine to be monitored by calling the kernel-mode driver of the corresponding virtual machine to be monitored includes at least one of the following: sending, through the virtualization monitoring unit and in response to the trigger instruction, an interrupt signal to the monitoring program object to obtain the memory statistical data of the virtual machine to be monitored; or sending, by the communication program object, the memory statistical data to the memory monitoring process.

According to one or more embodiments of the present disclosure, the memory statistical data includes at least one of the following: a first event number, a second event number, a third event number, a first number of scanned pages, a second number of scanned pages, a first number of reclaimed pages, and a second number of reclaimed pages. The first event number represents a number of occurrence of out-of-memory events. The second event number represents a number of occurrence of missing page fault events. The third event number represents a number of occurrence of direct memory reclamation events. The first number of scanned pages represents a number of memory pages scanned by a reclamation thread in a background memory reclamation event. The second number of scanned pages represents a number of memory pages scanned by a reclamation thread in a direct memory reclamation event. The first number of reclaimed pages represents a number of reclaimed memory pages in a background memory reclamation event. The second number of reclaimed pages represents a number of reclaimed memory pages in a direct memory reclamation event.

According to one or more embodiments of the present disclosure, the memory statistical data includes the first event number, and obtaining the memory pressure category according to the memory statistical data of the virtual machine to be monitored includes: obtaining an event change amount of the first event number within a detection period obtaining an event change amount of the first event number within a target detection period obtaining the event change amount of the first event number within the detection period; and obtaining the memory pressure category according to the event change amount of the first event number.

According to one or more embodiments of the present disclosure, the memory statistical data further includes a third event number, and obtaining the memory pressure category according to the event change amount of the first event number includes: if the event change amount of the first event number is greater than a first threshold, obtaining a first-level pressure category; and if the event change amount of the first event number is less than the first threshold, obtaining an event change amount of the third event number, and if the event change amount of the third event number is greater than a second threshold, obtaining a second-level pressure category.

According to one or more embodiments of the present disclosure, the memory statistical data includes a first number of reclaimed pages and a second number of reclaimed pages, and obtaining the memory pressure category according to the memory statistical data of the virtual machine to be monitored includes: obtaining a first change amount of reclaimed pages corresponding to the first number of reclaimed pages, obtaining a first change amount of reclaimed pages corresponding to the first number of reclaimed pages and a second change amount of reclaimed pages corresponding to the second number of reclaimed pages within the detection period; obtaining a change amount of a disk memory page according to a sum of the first change amount and the second change amount of reclaimed pages; and obtaining the memory pressure category according to the change amount of the disk memory page.

According to one or more embodiments of the present disclosure, the obtaining the memory pressure category according to the change amount of the disk memory page includes: obtaining a reclaimed disk bandwidth according to the change amount of the disk memory page and a size of the disk memory page; and if a ratio of the reclaimed disk bandwidth to a system disk bandwidth is greater than a third threshold, obtaining a third-level pressure category.

According to one or more embodiments of the present disclosure, the memory statistical data includes a first number of scanned pages and a second number of scanned pages, and the obtaining the memory pressure category according to the memory statistical data of the virtual machine to be monitored includes: obtaining a first change amount of scanned pages corresponding to the first number of scanned pages and a second change amount of scanned pages corresponding to the second number of scanned pages within a detection period; and if a sum of the first change amount of scanned pages and the second change amount of scanned pages is greater than a fourth threshold, obtaining a fourth-level pressure category.

According to one or more embodiments of the present disclosure, the memory statistical data includes a second event number, and the obtaining the memory pressure category according to the memory statistical data of the virtual machine to be monitored includes: if an event change amount of the second event number is greater than a fifth threshold, obtaining a fifth-level pressure category.

In a second aspect, according to one or more embodiments of the present disclosure, a memory pressure detection apparatus for a virtual machine is provided, including:

a trigger module, configured to send, by a memory monitoring process running in a host, a trigger instruction to a virtualization monitoring unit, where the virtualization monitoring unit corresponding one-to-one to a virtual machine to be monitored created by the host, and is configured to generate a corresponding interrupt signal in response to the trigger instruction;
a detection module, configured to obtain, by a kernel-mode driver of the virtual machine to be monitored in response to the interrupt signal output by the virtualization monitoring unit, memory statistical data of the virtual machine to be monitored, the memory statistical data representing a statistical indicator for a memory reclamation process of the virtual machine to be monitored; and
a processing module, configured to obtain a memory pressure category according to the memory statistical data of the virtual machine to be monitored.

According to one or more embodiments of the present disclosure, after the memory pressure category is obtained according to the memory statistical data of the virtual machine to be monitored, the trigger module is further configured to: generate a corresponding dynamic detection period according to the memory pressure category, where the dynamic detection period is used to control a frequency of sending the trigger instruction to the virtualization monitoring unit by the memory monitoring process. The trigger module is further configured to: periodically send, by the memory monitoring process based on the dynamic detection period, the trigger instruction to the virtualization monitoring unit.

According to one or more embodiments of the present disclosure, before the memory statistical data of the virtual machine to be monitored is obtained by calling the kernel-mode driver of the corresponding virtual machine to be monitored through the virtualization monitoring unit and in response to the trigger instruction, the detection module is further configured to: initialize the kernel-mode driver of the virtual machine to be monitored to generate a program parameter corresponding to the virtual machine to be monitored, where the program parameter is used to indicate a category of the statistical indicator corresponding to the memory statistical data; and create a monitoring program object and a communication program object according to the program parameter. The detection module is further configured to perform at least one of the following: send, through the virtualization monitoring unit and in response to the trigger instruction, an interrupt signal to the monitoring program object to obtain the memory statistical data of the virtual machine to be monitored; and send, through the communication program object, the memory statistical data to the memory monitoring process.

According to one or more embodiments of the present disclosure, the memory statistical data includes at least one of the following: a first event number, a second event number, a third event number, a first number of scanned pages, a second number of scanned pages, a first number of reclaimed pages, and a second number of reclaimed pages. The first event number represents a number of occurrence of out-of-memory events. The second event number represents a number of occurrence of missing page fault events. The third event number represents a number of occurrence of direct memory reclamation events. The first number of scanned pages represents a number of memory pages scanned by a reclamation thread in a background memory reclamation event. The second number of scanned pages represents a number of memory pages scanned by a reclamation thread in a direct memory reclamation event. The first number of reclaimed pages represents a number of reclaimed memory pages in a background memory reclamation event. The second number of reclaimed pages represents a number of reclaimed memory pages in a direct memory reclamation event.

According to one or more embodiments of the present disclosure, the memory statistical data includes the first event number, and the processing module is further configured to: obtain an event change amount of the first event number within a detection period obtaining an event change amount of the first event number within a target detection period obtaining the event change amount of the first event number within the detection period; and obtain the memory pressure category according to the event change amount of the first event number.

According to one or more embodiments of the present disclosure, the memory statistical data further includes a third event number, and the processing module is further configured to: if the event change amount of the first event number is greater than a first threshold, obtain a first-level pressure category; and if the event change amount of the first event number is less than the first threshold, obtain an event change amount of the third event number, and if the event change amount of the third event number is greater than a second threshold, obtain a second-level pressure category.

According to one or more embodiments of the present disclosure, the memory statistical data includes a first number of reclaimed pages and a second number of reclaimed pages, and the processing module is further configured to: obtain a first change amount of reclaimed pages corresponding to the first number of reclaimed pages, obtain a first change amount of reclaimed pages corresponding to the first number of reclaimed pages and a second change amount of reclaimed pages corresponding to the second number of reclaimed pages within the detection period; obtain a change amount of a disk memory page according to a sum of the first change amount of reclaimed pages and the second change amount of reclaimed pages; and obtain the memory pressure category according to the change amount of the disk memory page.

According to one or more embodiments of the present disclosure, the processing module is further configured to: obtain a reclaimed disk bandwidth according to the change amount of the disk memory page and a size of the disk memory page; and if a ratio of the reclaimed disk bandwidth to a system disk bandwidth is greater than a third threshold, obtain a third-level pressure category.

According to one or more embodiments of the present disclosure, the memory statistical data includes a first number of scanned pages and a second number of scanned pages, and the processing module is further configured to: obtain a first change amount of scanned pages corresponding to the first number of scanned pages and a second change amount of scanned pages corresponding to the second number of scanned pages within a detection period; and if a sum of the first change amount of scanned pages and the second change amount of scanned pages is greater than a fourth threshold, obtain a fourth-level pressure category.

According to one or more embodiments of the present disclosure, the memory statistical data includes a second event number, and the processing module is further configured to: if an event change amount of the second event number is greater than a fifth threshold, obtain a fifth-level pressure category.

In a third aspect, according to one or more embodiments of the present disclosure, an electronic device is provided, including: at least one processor and a memory;
the memory stores computer-executable instructions; and
the at least one processor executes the computer-executable instructions stored in the memory, causing the at least one processor to execute the memory pressure detection method for a virtual machine according to the above first aspect and various possible designs of the first aspect.

In a fourth aspect, according to one or more embodiments of the present disclosure, a computer-readable storage medium is provided, where the computer-readable storage medium stores computer-executable instructions, and the computer-executable instructions, when executed by a processor, implement the memory pressure detection method for a virtual machine according to the above first aspect and various possible designs of the first aspect.

In a fifth aspect, according to one or more embodiments of the present disclosure, a computer program product is provided, including a computer program, where the computer program, when executed by a processor, implements the memory pressure detection method for a virtual machine according to the above first aspect and various possible designs of the first aspect.

The above description is only preferred embodiments of the present disclosure and an illustration of the applied technical principles. Those skilled in the art should understand that the disclosure scope involved in the present disclosure is not limited to the technical solutions formed by a specific combination of the above technical features, and should also cover other technical solutions formed by any combination of the above technical features or equivalent features thereof without departing from the above disclosure concept, for example, a technical solution formed by replacing the above features with technical features with similar functions disclosed (but not limited to) in the present disclosure.

In addition, although various operations are described in a specific order, this should not be understood as requiring these operations to be performed in the specific order shown or in a sequential order. Under certain circumstances, multitasking and parallel processing may be advantageous. Likewise, although several specific implementation details are included in the above discussion, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

I/WE CLAIM:

1. A memory pressure detection method for a virtual machine, comprising:
sending, by a memory monitoring process running in a host, a trigger instruction to a virtualization monitoring unit, the virtualization monitoring unit being deployed in the host and corresponding one-to-one to a virtual machine to be monitored created by the host;
calling, by the virtualization monitoring unit and in response to the trigger instruction, a kernel-mode driver of a corresponding virtual machine to be monitored to obtain memory statistical data of the virtual machine to be monitored, the memory statistical data representing a statistical indicator for a memory reclamation process of the virtual machine to be monitored; and
obtaining a memory pressure category according to the memory statistical data of the virtual machine to be monitored.

2. The method according to claim 1, wherein after obtaining the memory pressure category according to the memory statistical data of the virtual machine to be monitored, the method further comprises:
generating a corresponding dynamic detection period according to the memory pressure category, the dynamic detection period being used to control a frequency of sending the trigger instruction to the virtualization monitoring unit by the memory monitoring process.

3. The method according to claim 1, wherein before obtaining the memory statistical data of the virtual machine to be monitored by calling the kernel-mode driver of the corresponding virtual machine to be monitored by the virtualization monitoring unit and in response to the trigger instruction, the method further comprises:
initializing the kernel-mode driver of the virtual machine to be monitored to generate a program parameter corresponding to the virtual machine to be monitored, wherein the program parameter is used to indicate a category of the statistical indicator corresponding to the memory statistical data; and
creating a monitoring program object and a communication program object according to the program parameter;
wherein obtaining, by the virtualization monitoring unit and in response to the trigger instruction, the memory statistical data of the virtual machine to be monitored by calling the kernel-mode driver of the corresponding virtual machine to be monitored comprises at least one of:
sending, by the virtualization monitoring unit and in response to the trigger instruction, an interrupt signal to the monitoring program object to obtain the memory statistical data of the virtual machine to be monitored; or
sending, by the communication program object, the memory statistical data to the memory monitoring process.

4. The method according to claim 1, wherein the memory statistical data comprises at least one of:
a first event number, a second event number, a third event number, a first number of scanned pages, a second number of scanned pages, a first number of reclaimed pages, or a second number of reclaimed pages;
wherein the first event number represents a number of occurrence of an out-of-memory event;
the second event number represents a number of occurrence of a missing page fault event;
the third event number represents a number of occurrence of a direct memory reclamation event;
the first number of scanned pages represents a number of memory pages scanned by a reclamation thread in a background memory reclamation event;
the second number of scanned pages represents a number of memory pages scanned by a reclamation thread in a direct memory reclamation event;
the first number of reclaimed pages represents a number of reclaimed memory pages in a background memory reclamation event; and
the second number of reclaimed pages represents a number of reclaimed memory pages in a direct memory reclamation event.

5. The method according to claim 4, wherein the memory statistical data comprises the first event number, and obtaining the memory pressure category according to the memory statistical data of the virtual machine to be monitored comprises:
obtaining an event change amount of the first event number within a detection period; and
obtaining the memory pressure category according to the event change amount of the first event number.

6. The method according to claim 5, wherein the memory statistical data further comprises a third event number, and obtaining the memory pressure category according to the event change amount of the first event number comprises:
in response to the event change amount of the first event number being greater than a first threshold, obtaining a first-level pressure category; and
in response to the event change amount of the first event number being less than the first threshold, obtaining an event change amount of the third event number, and in response to the event change amount of the third event number being greater than a second threshold, obtaining a second-level pressure category.

7. The method according to claim 4, wherein the memory statistical data comprises a first number of reclaimed pages and a second number of reclaimed pages, and obtaining the memory pressure category according to the memory statistical data of the virtual machine to be monitored comprises:
obtaining a first change amount of reclaimed pages corresponding to the first number of reclaimed pages and a second change amount of reclaimed pages corresponding to the second number of reclaimed pages within the detection period;
obtaining a change amount of a disk memory page according to a sum of the first change amount of reclaimed pages and the second change amount of reclaimed pages; and
obtaining the memory pressure category according to the change amount of the disk memory page.

8. The method according to claim 7, wherein obtaining the memory pressure category according to the change amount of the disk memory page comprises:
obtaining a reclaimed disk bandwidth according to the change amount of the disk memory page and a size of the disk memory page; and
in response to a ratio of the reclaimed disk bandwidth to a system disk bandwidth being greater than a third threshold, obtaining a third-level pressure category.

9. The method according to claim 4, wherein the memory statistical data comprises a first number of scanned pages and a second number of scanned pages, and obtaining the memory pressure category according to the memory statistical data of the virtual machine to be monitored comprises:
obtaining a first change amount of scanned pages corresponding to the first number of scanned pages and a second change amount of scanned pages corresponding to the second number of scanned pages within a detection period; and
in response to a sum of the first change amount of scanned pages and the second change amount of scanned pages being greater than a fourth threshold, obtaining a fourth-level pressure category.

10. The method according to claim 4, wherein the memory statistical data comprises a second event number, and obtaining the memory pressure category according to the memory statistical data of the virtual machine to be monitored comprises:
in response to an event change amount of the second event number being greater than a fifth threshold, obtaining a fifth-level pressure category.

11. An electronic device, comprising: a processor and a memory;
wherein the memory stores computer-executable instructions; and
the processor executes the computer-executable instructions stored in the memory, causing the processor to:
send, by a memory monitoring process running in a host, a trigger instruction to a virtualization monitoring unit, the virtualization monitoring unit being deployed in the host and corresponding one-to-one to a virtual machine to be monitored created by the host;
call, by the virtualization monitoring unit and in response to the trigger instruction, a kernel-mode driver of a corresponding virtual machine to be monitored to obtain memory statistical data of the virtual machine to be monitored, the memory statistical data representing a statistical indicator for a memory reclamation process of the virtual machine to be monitored; and
obtain a memory pressure category according to the memory statistical data of the virtual machine to be monitored.

12. The device according to claim 11, wherein after the instructions causing the device to obtain the memory pressure category according to the memory statistical data of the virtual machine to be monitored, the device is further caused to:
generate a corresponding dynamic detection period according to the memory pressure category, the dynamic detection period being used to control a frequency of sending the trigger instruction to the virtualization monitoring unit by the memory monitoring process.

13. The device according to claim 11, wherein before the instructions causing the device to obtain the memory statistical data of the virtual machine to be monitored by calling the kernel-mode driver of the corresponding virtual machine to be monitored by the virtualization monitoring unit and in response to the trigger instruction, the device is further caused to:
initialize the kernel-mode driver of the virtual machine to be monitored to generate a program parameter corresponding to the virtual machine to be monitored, wherein the program parameter is used to indicate a category of the statistical indicator corresponding to the memory statistical data; and
create a monitoring program object and a communication program object according to the program parameter;
wherein the instructions causing the device to obtain, by the virtualization monitoring unit and in response to the trigger instruction, the memory statistical data of the virtual machine to be monitored by calling the kernel-mode driver of the corresponding virtual machine to be monitored comprise at least one of the instructions causing the device to:
send, by the virtualization monitoring unit and in response to the trigger instruction, an interrupt signal to the monitoring program object to obtain the memory statistical data of the virtual machine to be monitored; or
send, by the communication program object, the memory statistical data to the memory monitoring process.

14. The device according to claim 11, wherein the memory statistical data comprises at least one of:
a first event number, a second event number, a third event number, a first number of scanned pages, a second number of scanned pages, a first number of reclaimed pages, or a second number of reclaimed pages;
wherein the first event number represents a number of occurrence of an out-of-memory event;
the second event number represents a number of occurrence of a missing page fault event;
the third event number represents a number of occurrence of a direct memory reclamation event;
the first number of scanned pages represents a number of memory pages scanned by a reclamation thread in a background memory reclamation event;
the second number of scanned pages represents a number of memory pages scanned by a reclamation thread in a direct memory reclamation event;
the first number of reclaimed pages represents a number of reclaimed memory pages in a background memory reclamation event; and
the second number of reclaimed pages represents a number of reclaimed memory pages in a direct memory reclamation event.

15. The device according to claim 14, wherein the memory statistical data comprises the first event number, and the instructions causing the device to obtain the memory pressure category according to the memory statistical data of the virtual machine to be monitored comprise the instructions causing the device to:
obtain an event change amount of the first event number within a detection period; and
obtain the memory pressure category according to the event change amount of the first event number.

16. The device according to claim 15, wherein the memory statistical data further comprises a third event number, and the instructions causing the device to obtain the memory pressure category according to the event change amount of the first event number comprise the instructions causing the device to:
in response to the event change amount of the first event number being greater than a first threshold, obtain a first-level pressure category; and
in response to the event change amount of the first event number being less than the first threshold, obtain an event change amount of the third event number, and in response to the event change amount of the third event number being greater than a second threshold, obtain a second-level pressure category.

17. The device according to claim 14, wherein the memory statistical data comprises a first number of reclaimed pages and a second number of reclaimed pages, and the instructions causing the device to obtain the memory pressure category according to the memory statistical data of the virtual machine to be monitored comprise the instructions causing the device to:
obtain a first change amount of reclaimed pages corresponding to the first number of reclaimed pages and a second change amount of reclaimed pages corresponding to the second number of reclaimed pages within the detection period;
obtain a change amount of a disk memory page according to a sum of the first change amount of reclaimed pages and the second change amount of reclaimed pages; and
obtain the memory pressure category according to the change amount of the disk memory page.

18. The device according to claim 17, wherein the instructions causing the device to obtain the memory pressure category according to the change amount of the disk memory page comprise the instructions causing the device to:
obtain a reclaimed disk bandwidth according to the change amount of the disk memory page and a size of the disk memory page; and
in response to a ratio of the reclaimed disk bandwidth to a system disk bandwidth being greater than a third threshold, obtain a third-level pressure category.

19. The device according to claim 14, wherein the memory statistical data comprises a first number of scanned pages and a second number of scanned pages, and the instructions causing the device to obtain the memory pressure category according to the memory statistical data of the virtual machine to be monitored comprise the instructions causing the device to:
obtain a first change amount of scanned pages corresponding to the first number of scanned pages and a second change amount of scanned pages corresponding to the second number of scanned pages within a detection period; and
in response to a sum of the first change amount of scanned pages and the second change amount of scanned pages being greater than a fourth threshold, obtain a fourth-level pressure category.

20. A non-transitory computer-readable storage medium, wherein the non-transitory computer-readable storage medium stores computer-executable instructions, and the computer-executable instructions, when executed by a processor, causing the processor to:
send, by a memory monitoring process running in a host, a trigger instruction to a virtualization monitoring unit, the virtualization monitoring unit being deployed in the host and corresponding one-to-one to a virtual machine to be monitored created by the host;
call, by the virtualization monitoring unit and in response to the trigger instruction, a kernel-mode driver of a corresponding virtual machine to be monitored to obtain memory statistical data of the virtual machine to be monitored, the memory statistical data representing a statistical indicator for a memory reclamation process of the virtual machine to be monitored; and
obtain a memory pressure category according to the memory statistical data of the virtual machine to be monitored.
